(19) United States
(12) Patent Application Publication
(10) Pub. No.: US 2006/0082089 A1
(43) Pub. Date: Apr. 20, 2006

(54) Versatile sports board

(76) Inventor: Demetrias Rejtano, Bargara (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/968,824

(22) Filed: Oct. 18, 2004

(51) Int. Cl. A63C 5/04; B62M 1/00

(52) U.S. Cl. 280/87.042; 280/609

(57) ABSTRACT

A versatile sports board comprising a top deck for supporting an operator, continuous side wall extending from the top deck and a bottom wall extending from the side wall, wherein the top deck, side wall and bottom wall define an internal cavity containing gas and, optionally, a lightweight material. The sports board preferably includes two reinforcing ribs formed in the bottom wall. The ribs may be formed as inverted U shaped structures. The sports board may further incorporate foot restraint means and also may be adapted to receive skateboard trucks. In a further embodiment, the board may include a recess adapted to form a universal coupling with a base support so that an operator can practice balance and manoeuvres.

### FIELD OF THE INVENTION

THIS INVENTION relates to devices for recreational and competitive sporting pursuits. In particular, the present invention relates to a sports board for use by an operator in one or more sporting activities. More particularly, the invention is directed to a versatile sports board which can be used in a number of different pursuits. The invention is also directed to a versatile sports board that may be used as a training device and, preferably, a sports board which is lightweight, durable and adaptable to different applications.

### BACKGROUND OF THE INVENTION

Sports enthusiasts have long been known to use boards in a variety of different recreational pursuits. These pursuits have included snowboarding, wherein a participant mounts a snowboard and conducts a series of manoeuvres during a downhill run. It is also known to use sports boards on long sand hills. The sand islands of a number of countries are famous for providing excellent sporting runs with associated challenge and enjoyment for participants. Sports boards may also be formed as skateboards, wherein mobility is provided by a set of skateboard trucks often incorporating high quality and high technology wheel components to provide considerable speed and manoeuvrability in operation.

It is further known to use boards as an alternative for skis when towed behind a powerboat. The boards provide a support device which again is manoeuvrable and allows an operator to track directly behind a boat or swerve from side to side across the boat's wake.

Snowboards, for example, have a similar construction to that of snow skis usually with wood or foam cores, vertical or horizontal lamination, carbon and kevlar reinforcement, varied flex patterns, steel wrapped around the edges, protected tips and tails and other components. There are basically two types of boards that are used depending on the style of snowboarding that will be undertaken. Free riding is the more downhill oriented side of the sports, but free style is usually a higher profile, competitive-type pursuit.

These snowboards normally have bindings for attachment of feet to the board. The bindings often are a base plate with ratcheting straps. The bindings do not release like ski bindings, as the feet need to be secured to the board when in motion.

Typically, a snowboard is constructed in a number of layers of different material. On the bottom is often a layer of UHMW (Ultra High Molecular Weight) polyethylene. The base is usually surrounded by steel edges so the board will dig into the snow when turning. Next, a layer of fibreglass or fibreglass reinforced plastic is applied and this provides stiffness and strength to the board. This is followed by the core which is usually wood or foam with sets of metal inserts needed to mount bindings. Another layer of fibreglass lays on top of the core and the top layer is a protective plastic layer called a top sheet. The layers are usually bonded together with an adhesive or glue that holds them together and is usually in the form of an epoxy resin. The structure is therefore a relatively complex arrangement which takes a considerable amount of time and effort, particularly as each layer of snowboard is usually positioned in a mould before the epoxy resin is cured by the application of heat over a period of time. Additionally, a snowboard is usually only suitable for use as a snowboard.

A skateboard, on the other hand, is usually formed as a mono- or multi-layer and substantially planar deck with skateboard trucks attached fore and aft. The skateboard is restricted in use to operation as a skateboard. Neither conventional snowboards or skateboards are of any use in a water environment. Further, although skateboards may be used widely, sliding type boards are restricted to suitable environments such as snow and sand and cannot be utilised in other locations.

It would be beneficial to provide a single, versatile sports board which could be easily and cheaply constructed and, preferably, which could be used in more than one application and, preferably, more than one location.

It would also be of advantage if such a board was adapted to provide a training device for users.

Reference to any prior art in this specification is not, and should not be taken as, an acknowledgment or any form of suggestion that this prior art forms part of the common general knowledge in any country.

### SUMMARY OF THE INVENTION

Throughout this specification, unless the context requires otherwise, the word “comprise”, or variations such as “comprises” or “comprising”, will be understood to imply the inclusion of a stated element or integer or group of elements or integers but not the exclusion of any other element or integer or group of elements or integers.

In a first aspect, the invention resides in a versatile sports board comprising:

a top deck adapted to support an operator;

a continuous side wall extending from the top deck; and

a bottom wall extending from the side walls;

wherein the top deck, side wall and bottom wall together define a central cavity containing gas and/or a lightweight reinforcing material.

The top deck, side walls and bottom wall are preferably integrally formed and may be moulded. The junction of the side wall and bottom wall is preferably formed as a rounded shoulder.

The sports board may be formed from fibreglass, graphite, Kevlar or even wood. It is preferred, however, if the sports board is formed of a plastic material.

The plastic material is preferably polyethylene and, most preferably, high density polyethylene such as UHMW polyethylene. In this specification, gas should be understood to include mixtures of gases.

The cavity may be air filled. Other gases may be used. A preferred gas is helium. Alternatively, the cavity may be filled, at least in part, with a lightweight reinforcing material such as polystyrofoam or expanded foam or similar.

The sports board preferably has an upwardly curved nose section continuous with a first surface recess adapted to receive a leading foot of an operator. The first surface recess may be continuous with a reinforced central region. The central region may be reinforced by thickened walls and/or an enlarged transverse circumference.

The central region may be continuous with a rearward top deck recess adapted to receive a trailing foot of an operator. The rearward recess may be continuous with an upwardly curved tail section. In one embodiment, the board is reversible in operation to interchange the nose and tail sections.

The nose and/or tail sections are preferably formed to be temporarily deformable, thereby providing variation of performing characteristics. After deformation, the nose and/or tail sections may gradually return to their original configuration due to inherent resilience of the material from which the board is constructed.

The sports board preferably has one or more strengthening ribs arranged longitudinally along its lower surface. The strengthening rib may be formed as a channel recessed into the bottom surface. Preferably, two spaced parallel channels are formed in the bottom surface. Each may be equally spaced either side of a central midline axis. Each channel may be formed with an inverted U shaped cross-section. The channels may extend substantially along the full length of the bottom wall.

The bottom wall may be slightly concave, particularly around the middle half of the board.

The board may further comprise foot restraint means. The foot restraint means may be removable. The foot restraint means may be formed as straps attached to the top deck. The straps may include hook and pile type fasteners for variable fixing of the straps to accommodate different sized feet. The foot restraint means may further comprise loops for positioning behind the ankles and to assist in control of the board during manoeuvres.

The sports board may be dimensioned sufficiently wide to act as a toboggan for operation by lying or sitting on the board. The sports board may include directional control reins or handles mounted to the front of the board.

The sports board may further comprise a curved recess formed centrally in the bottom wall and a separate base, the base having an upper curved structure dimensioned to fit into the curved recess to form a separable universal coupling.

Preferably, both the recess and upper structure are formed as complementary portions of spheres. The recess may be substantially hemispherical. The upper structure may be hemispherical but preferably is more ball-like. It may form around ¾ of a sphere supported upwardly on the base. The universal coupling may be suitable for static training purposes including practicing manoeuvres.

The sports board may further include mounting means for receiving a skateboard truck at both front and rear regions. The mounting means may comprise one or more threaded bores adapted to receive a bolt or other suitable fixing arrangement which, in turn, is engageable with the skateboard truck. Preferably, four threaded bores are provided for each skateboard truck. The sports board may further comprise caps or covers for location over the threaded bores when not in use with a skateboard truck.

In a further aspect, the invention resides in a system for operation of a sports board, the said system comprising a sports board as described above and sheeting material for overlaying a track surface, preferably a concrete track surface. The synthetic sheeting material is preferably formed as a perforate plastic material. Preferably, the plastic sheeting material is a polyethylene mesh and optionally a high density polyethylene mesh. The sheeting may be fibreglass or other synthetic material as appropriate. Any sheeting material that reduces friction with the sports board may be suitable. Plastic sheeting, shade cloth and tarpaulins may all be useful. Generally, it is preferred to use a mesh material to minimise function.

### BRIEF DESCRIPTION OF THE DRAWINGS

In order to provide a better understanding of the present invention, preferred embodiments will be described in detail, by way of example only, with reference to the accompanying drawings in which:

FIG. 1 is a bottom isometric view of a sports board of the present invention;

FIG. 2 is a top isometric view of a sports board of the present invention;

FIG. 3 is a side view of the sports board of FIG, 1;

FIG. 4 is a sectional view of the sports board of FIG. 3 taken along the line AA;

FIG. 5 is a sectional view of the sports board of FIG. 3 taken along the line BB;

FIG. 6 is a top plan view of a base for use with the sports board;

FIG. 7 is a side of the base of FIG. 6;

FIG. 8 is a side view of the base and sports board in use;

FIG. 9 is an isometric view of a sports board with feet restraints;

FIG. 10 is a part sectional isometric view of attachment of a skateboard track aligned for mounting to the sports board of the present invention;

FIG. 11 is a schematic view of the sports board in operation; and

FIG. 12 is a top plan view of a sports board in a configuration suitable for tobogganing.

### DETAILED DESCRIPTION OF THE DRAWINGS

Referring to FIG. 1, there is seen a sports board 10 in bottom isometric view. The sports board 10 has a continuous side wall 12 and bottom wall 14. The bottom wall 14 has two longitudinal spaced recessed ribs 16, 18. The ribs may be spaced equally around a central longitudinal axis (not shown). A hemispherical recess 20 is formed in the bottom wall and is described further below. A central region 22 of the board 10 is slightly thickened to provide reinforcement in its structure. The central region has an increased transverse circumference adapted to provide reinforcing to the board. The board has a nose section 24 and a tail section 26.

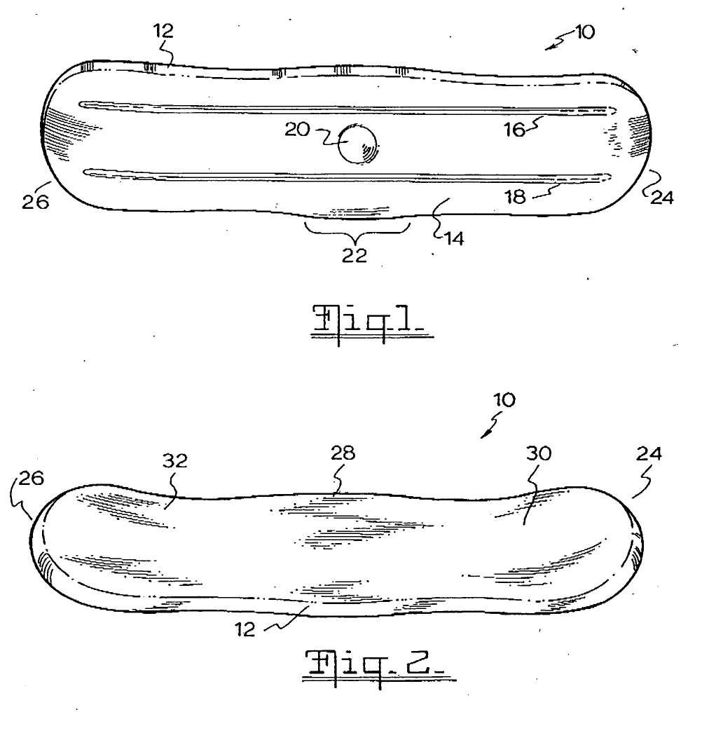

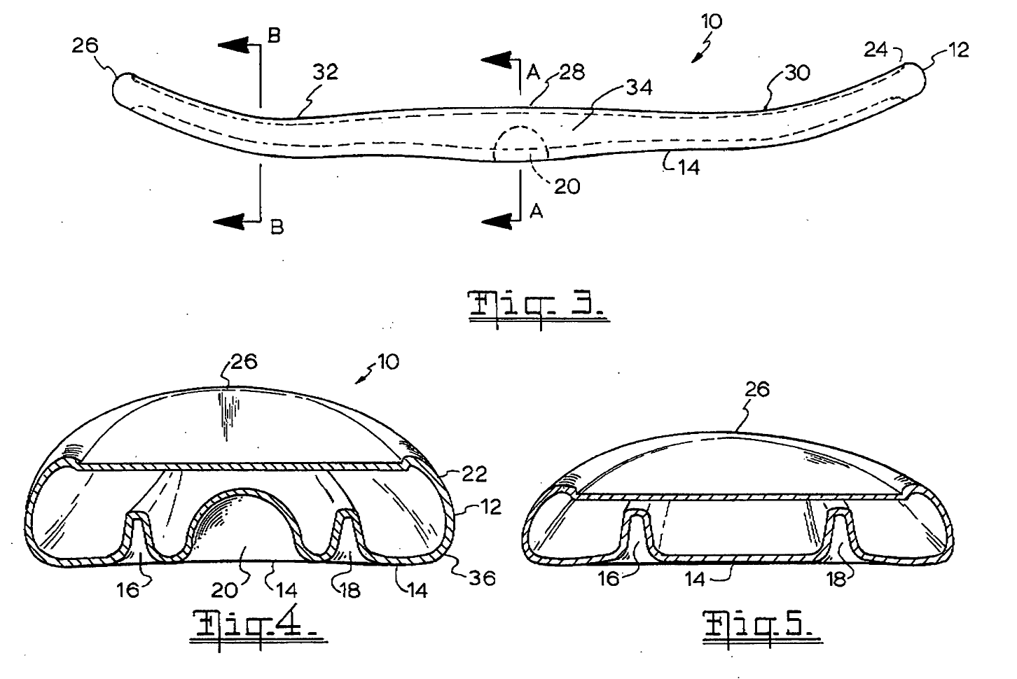

Referring to FIG. 2, it can be seen that a top deck 28 of the board is formed integrally with the continuous side wall 12 and bottom wall 14. A first surface recess 30 is provided to receive a leading foot of an operator and is positioned between the nose section 24 and central region 22. A second surface recess 32 is provided to receive a trailing foot of an operator. In one embodiment, the board is symmetrical around a transverse central axis so that the nose section and tail section are interchangeable in operation to provide increased options for an operator to reverse the board and his or her bodily position while maintaining the direction of travel.

FIG. 3 shows a side view of the board 10 with an internal cavity 34 defined by inner surfaces of the top deck 28, side walls 12 and bottom wall 14 which are shown in hidden detail. The cavity may be air or gas filled. A preferred gas is helium. The presence of a gas provides an enhanced shock absorption capacity in the board which coupled with the preferred material, high density polyethylene, results in improved performance. Alternatively, the cavity may be filled at least in part with a lightweight reinforcing material such as expanded polystyrofoam, foam, or similar. The empty cavity allows for a relatively light board to be provided which is still strong. Positive buoyancy provides a board that may be used in some water sports. As is apparent, the nose section 24 and tail section 26 are both “kicked up” to provide a ramped bottom surface in travelling along a track or path. An operator may also use these features to flip the board to clear a track surface and facilitate airborne manoeuvres. In a preferred embodiment, the material forming the board is chosen to allow deformation of the nose and/or tail sections to increase the angle of the turned up section temporarily. This provides an alteration in the handling characteristics of the sports board for the performance of one or more manoeuvres. Natural resilience of the material from which the board is formed allows the nose and tail sections to slowly revert to their normal or ordinary configuration after use in the selected application. UHMW polyethylene is particularly well suited for this application.

The hemispherical recess 20 is also seen in hidden detail. The surface recesses 30, 32 are in fact shallow concavities provided in the top deck to receive and partially localise the feet of an operator.

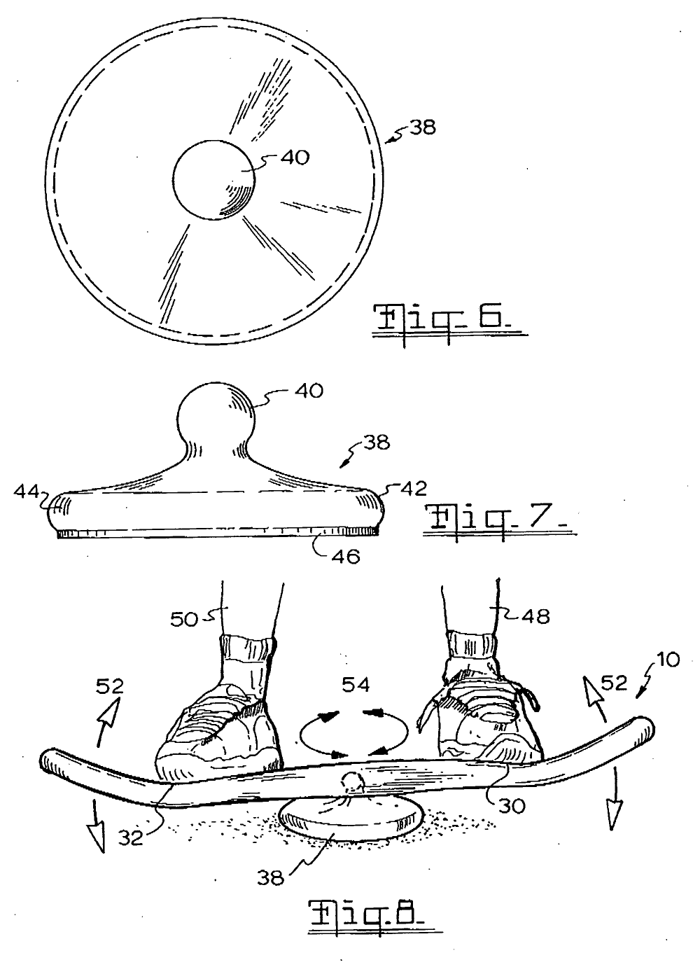

FIG. 4 shows a section looking in the direction of arrows AA of FIG. 3 and highlighting the reinforcing ribs 16, 18 which are formed longitudinally in the bottom of the board to provide strength and support to the arrangement. The tail section 26 is apparent extending away from the central region 22 which can be seen to be broadest at this point. The side wall 12 merges with the bottom wall 14 with rounded shoulders which provide a less severe cutting action when using the board on surfaces such as those that are lined with plastic or on grass, sand, snow or other surfaces. The recess 20 is also readily apparent in this view. The ribs 16, 18 are formed as inverted U channels to provide bracing through the length of the board. It should be noted that in FIG. 4, the bottom wall 14 is formed with a slight concavity. This may extend around a middle half or so of the board. This can provide advantage in the function of the device as it provides a slight air pocket between sections of the bottom wall 14 and a support surface on which it is being used, thereby decreasing friction and distributing the weight of the board and rider around the periphery. The inventors have found this arrangement gives some advantage in operation.

FIG. 5 shows a view taken in the direction of arrows BB of FIG. 3, wherein the depth of the board has decreased in the approach to the tail section 26. The ribs 16, 18 are still apparent and the concavity has been replaced substantially by a straight line to the bottom wall 14.

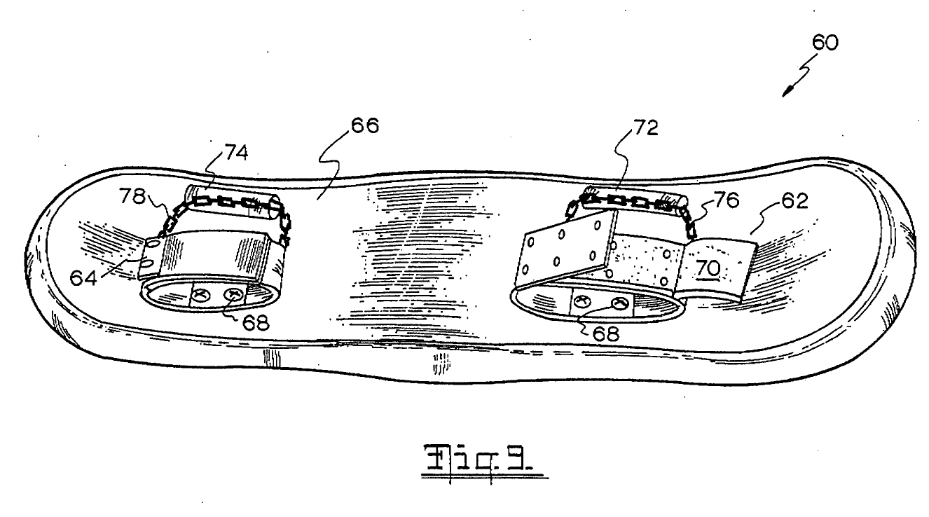

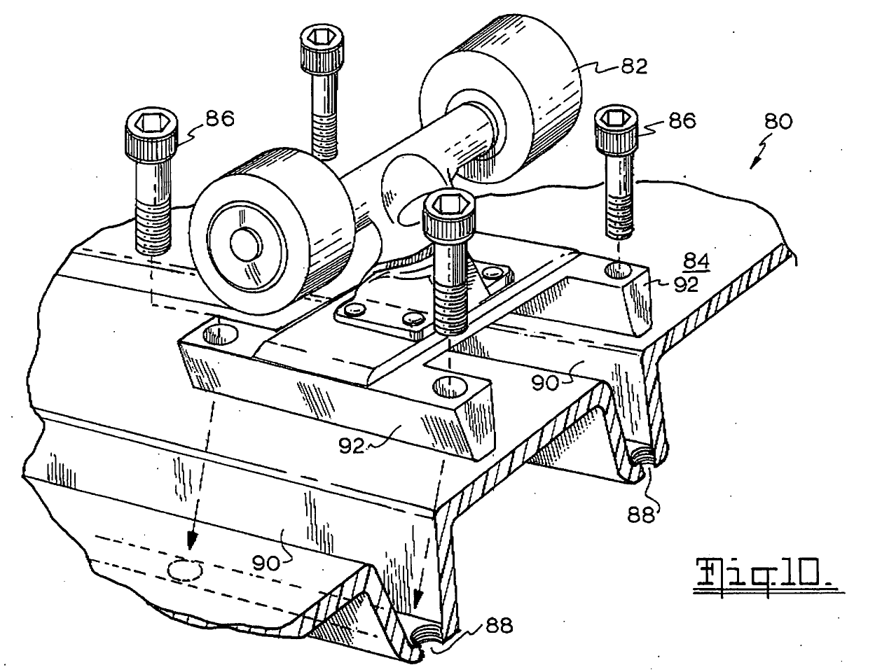

A base for use with the preferred embodiment of the present invention is shown in FIG. 6 as a circular construction 38 formed with a central substantially ball-like member 40 also apparent in FIG. 7. The member 40 shown in this figure extends beyond hemispherical to form a ball-type feature for coupling with a curved and substantially hemispherical socket. The member 40 is supported upwardly from and by a base section 42 having a curved side wall 44 which extends slightly outwardly of a discoid ground engaging section 46.

FIG. 8 shows the board 10 mounted to the base 38 with an operator having an anterior leg 48 and trailing leg 50 positioned on the recesses 30, 32 previously described.

The ball-like or hemispherical member 40 locates in the recess or socket 20 to provide a universal coupling which allows movement of the nose and tail regions of the board in the upward and downward direction 52 and rotationally in a plane parallel to the ground surface as shown by arrows 54. The board 10 may also pivot from the foreground to the background of the view shown, thereby providing movement in all three dimensions and enhancing the training utility of the present arrangement. This arrangement provides an operator with the chance to practice moves, improve balance and generally become accustomed to the function of the device. As an operator gains experience, he or she may be able to perform tricks while on the base, even to the point of kicking the board off the base into the air and then redirecting it onto the base to reform the universal coupling.

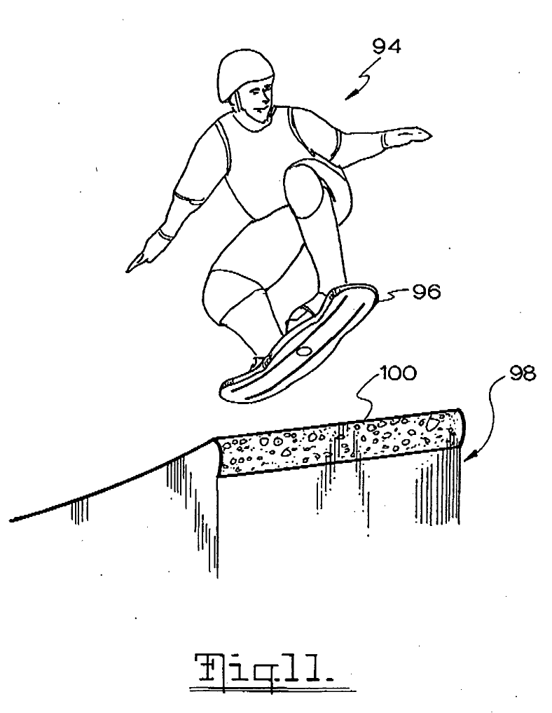

FIG. 9 shows a sports board 60 with one example of foot restraint means in the form of straps 62, 64 fixed to the top deck 66 by screws 68. The straps 62, 64 are preferably formed with hook and loop fasteners 70 such as Velcro® allowing easy adjustment of the straps to different sized feet. The present straps also have ankle loops 72, 74 positioned on attachment chains 76, 78, respectively. The ankle loops are formed with a plastic outer sleeve and adapted to locate behind the ankle and in contact with an operator's Achilles tendon thereby giving greater control of the board.

A further variation of a sports board 80 is shown in part-sectional view in FIG. 10, wherein a skateboard truck 82 is fixed to the bottom wall 84 by bolts 86 adapted to fit into threaded bores 88 formed in the channels 90 with a matching rail 92 formed as an inverted U to nest in a stable fashion in the channels 90. A skateboard truck 82 may be fitted fore and aft on the board to provide a skateboard. Skateboard trucks are well known and readily available and may be easily manufactured or modified to conform to the profile of the board 80. When not in use, the bolts 86 may be screwed fully into the bores 88 to protect them and minimise the opportunity for damage of the board. Alternatively, flush fitting caps may be provided for location in the bores 88. Other mechanisms may be used for attaching the trucks such as a plate provided to sit across the bottom wall 84 with through bolts located through bores from the top deck to bottom wall 84 (not shown).

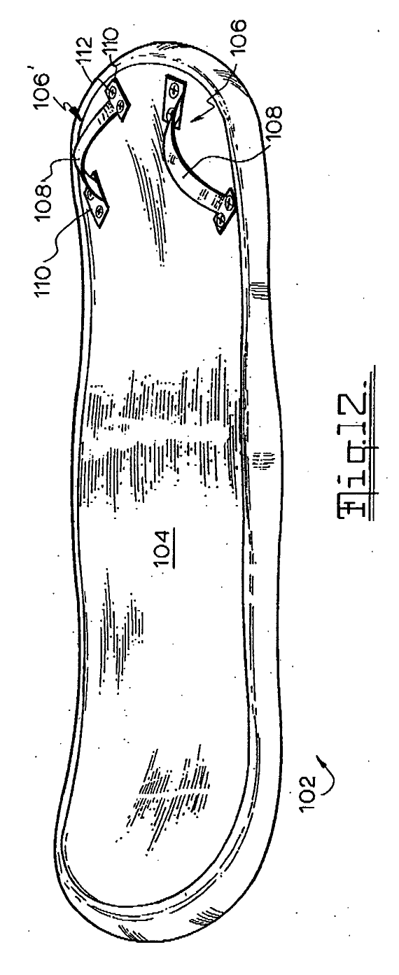

FIG. 11 shows a schematic view of an operator 94 on a board 96 jumping off a ramp 98. While the present board may be used on many surfaces, the inventors have found that the use of a synthetic material, preferably slippery, such as a perforated polymeric sheet material 100, may be of great assistance in decreasing friction. A particular suitable material is “oyster mesh” which is both readily available and relatively cheap. Oyster mesh is often used for construction of oyster baskets, cages and trays. It is available in different mesh sizes and a representative range is 3 mm to 23 mm which may be high density polyethylene. The mesh may be provided in rolls of approximately 1 m wide×50 m long. A ramp may be formed specifically for use with the board or, alternatively, known skateboard-type bowls may be suitable when overlaid with such a material to allow the performance of competition and recreational activities. This is particularly the case in relation to extreme sport-type uses.

FIG. 12 shows a board 102 which has been configured with a body 104 to provide increased utility as a toboggan. The board 102 may receive a person sitting or kneeling on the body 104 or even lying on the body. Directional controls 106 are provided as reins or handles at the front of the device. These reins or handles also aid in stabilising the operator on the board. The handles 106 have a strap 108 with feet 110 formed either end having apertures 112 adapted to receive fixing screws. The handles may be formed of leather. The toboggan embodiment is particularly well suited for snow but may also be used elsewhere. The buoyancy referred to previously may be of assistance in the environment of a body board in a water body such as a lake, dam or the ocean.

The advantages of the present invention are readily apparent in that a sports board is provided which may be used as one or more of a snowboard, a sand board, an earth or grass surfer, a skateboard and a toboggan. The device may be relatively cheaply formed and is preferably rotation moulded. The production may be accomplished by placing a weighed amount of plastic granules in a mould. The mould may then be “cooked” in a rotation oven to 240° C. for an appropriate time. The mould is then cooled, unloaded and trimmed. The dimensions may be any suitable range for the purpose intended. In one preferred embodiment, the board may be around 900 mm long with a top deck of approximately 170 mm width. The top deck may form a shoulder onto an outwardly curved side wall which has a depth of approximately 50 mm maximum and down to around 30 mm. The nose may kick up approximately 40 mm on the top surface and similar on the tail section. The nose and tail sections are preferably curved at their leading edge. The recesses may approximately 15 mm deep and the hemispherical recess may have a diameter of around 40 mm. It may be larger or smaller as needed.

The present invention may also be used in its training configuration for safe acquisition of riding skills.

Throughout the specification, the aim has been to describe the preferred embodiments of the invention without limiting the invention to any one embodiment or specific collection of features. Those of skill in the art will therefore appreciate that, in light of the instant disclosure, various modifications and changes can be made in the particular embodiments exemplified without departing from the scope of the present invention. All such modifications and changes are intended to be included within the scope of the appendant claims.

1. A versatile sports board comprising:
a top deck adapted to receive and support an operator;
a continuous side wall extending from the top deck; and
a bottom wall extending from the side wall;
wherein the top deck side wall and bottom wall together define an internal cavity containing gas and, optionally, a lightweight material.

2. The versatile sports board of claim 1 formed from one or more of plastic, high density polyethylene, fibreglass, Kevlar, graphite reinforced plastic or wood.

3. The versatile sports board of claim 1 when formed from high density polyethylene.

4. The versatile sports board of claim 1, wherein the top deck, side wall and bottom wall are formed integrally.

5. The versatile sports board of claim 3, wherein the top deck, side wall and bottom wall are formed by rotational moulding.

6. The versatile sports board of claim 5, wherein a junction of the side wall and bottom wall is formed as a rounded shoulder.

7. The versatile sports board of claim 1, wherein the internal cavity is filled with air.

8. The versatile of sports board of claim 1, wherein the internal cavity is filled with helium.

9. The versatile sports board of claim 1, further comprising an upwardly curved nose section and an upwardly curved tail section.

10. The versatile sports board of claim 9, wherein the nose section is continuous with a first surface recess adapted to receive a leading foot of an operator, the first surface recess continuous with a reinforced central region which, in turn, comprises thickened walls and/or an enlarged transverse circumference.

11. The versatile sports board of claim 10, wherein the central region is continuous with a second surface recess adapted to receive a trailing foot of an operator, the second surface continuous with the tail section.

12. The versatile sports board of claim 11, wherein the board is reversible in REST AVAILABLE COPY operation.

13. The versatile sports board of claim 9, wherein the nose and/or tail sections are temporarily deformable, thereby providing variation of performance characteristics.

143. The versatile sports board of claim 13, wherein the nose or tail sections gradually return to their original configuration after deformation, due to inherent resilience of the material from which the sports board is formed.

15. The versatile sports board of claim 9, wherein one or more strengthening ribs are arranged longitudinally along the lower surface.

16. The versatile sports board of claim 15, wherein the one or more strengthening ribs are formed as a channel recessed into the bottom surface.

17. The versatile sports board of claim 16, wherein two spaced parallel channels are formed in the bottom sure, the channels equally spaced either side of a central midline axis.

18. The versatile sports board of claim 17, wherein each channel is formed with an inverted U shaped cross-section.

19. The versatile sports board of claim 18, wherein the channels extend substantially along the full length of the bottom wall.

20. The versatile sports board of claim 19, wherein the bottom wall is slightly concave around a middle half of the board.

21. The versatile sports board of clam 20, wherein the board further comprises foot restraint means.

22. The versatile sports board of claim 21, wherein the foot restraint means are removable.

23. The versatile spot board of claim 22, wherein the foot restraint means are formed as straps attached to the top deck and include hook and pile-type fasteners for variable fixing of the straps to accommodate different sized feet.

24. The versatile sports board of claim 23, wherein the foot restraint means further comprise ankle loops to assist in control of the board during manoeuvres.

25. The versatile sports board of claim 19, further comprising a curved recess formed centrally in the bottom wall and a separate base, the base having an upper curved structure dimensioned to fit into the curved recess to form a separable universal coupling.

26. The versatile sports board of claim 25, wherein the recess and upper structure are formed as complementary hemispherical and ball-like configurations, respectively.

27. The versatile sports board of claim 19, wherein the board is dimensioned sufficiently wide to act as a toboggan for operation by an operator when lying or sitting on the board.

28. The versatile sports board of claim 27, further including directional control reins or handles mounted to the front of the board.

29. The versatile sports board of claim 19, further comprising mounting means for receiving a skateboard truck at both front and rear regions.

30. The versatile sports board of claim 29, wherein the mounting means comprises one or more threaded bores adapted to receive a bolt or other suitable fixing arrangement which, in turn, is engageable with the skateboard truck.

31. The versatile sports board of claim 30, further comprising four threaded bores provided for each skateboard truck.

32. The versatile sports board of claim 31, further comprising caps or covers for location over the threaded bores when not in use with the skateboard tucks.

33. A system for recreational sports, the system comprising a sports board according to claim 19 or claim 25 and sheeting material for overlying a track surface.

34. The system of claim 33, wherein the track surface is a concrete track surface.

35. The system of claim 33, wherein the sheeting material is formed from a perforate plastic material.

36. The system of claim 35, wherein the sheeting material is a high density polyethylene mesh.

37. A sports board substantially as described herein with reference to the figures.
